(19) United States
(12) Patent Application Publication
(10) Pub. No.: US 2007/0099617 A1
(43) Pub. Date: May 3, 2007

(54) Selection of target cell and intersystem cell reselection

(75) Inventor: Janne Sipila, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/319,270

(22) Filed: Dec. 29, 2005

(30) Foreign Application Priority Data
Oct. 27, 2005 (FI) 20055578

(51) Int. Cl. H04Q 7/20

(52) U.S. Cl. 455/436

(57) ABSTRACT

In a radio system the user terminal performs measurements of at least one pilot signal. The user terminal has a packet switched connection with a GSM cell. At least one of the at least one measured pilot signals is transmitted by a UTRAN cell. The user terminal transmits measurement reports including pieces of information of quality of the at least one pilot signal to a base station controller which compares the quality of the at least one pilot signal originating from a UTRAN cell with a predetermined threshold. The base station controller (106) selects a UTRAN cell as a target of an intersystem cell reselection if the quality of the pilot signal from the UTRAN cell maintains better than a predetermined threshold for a predetermined threshold period of time.

### FIELD

The invention relates to a method of selecting a target for an intersystem cell reselection and of performing an intersystem cell reselection in a telecommunication system including at least one Universal Mobile Telephone System Terrestrial Radio Access Network (UTRAN) cell and at least one Global System for Mobile Communications (GSM) cell. The invention relates also to a radio system, a base station controller and a computer program capable of performing the methods.

### BACKGROUND

In digital cellular networks one can move from the coverage area of one cell to another without losing connection. This is possible because of a handover performed between cells. In packet switched connections the handover is also called a cell reselection.

An intersystem handover (ISHO) may become necessary for a moving user terminal when coverage areas of two radio systems are at least partly overlapping or side by side. For example, in urban areas the UTRAN (UMTS Terrestrial Radio Access Network) is being introduced, whereas the development in rural areas is slower and the GSM (Global System for Mobile Communications) with packet switching feature will still be employed in the near future without competition from the UTRAN.

An ISHO is also required in order to take advantage of coverage areas of GSM and UTRAN cells overlapping each other. When the data transmission is on, a dual mode user terminal typically chooses a UTRAN cell whenever it is available. Only when the user terminal is moving out of the UTRAN coverage area and signal quality deteriorates to worse, the user terminal is forced to perform a handover to the best possible GSM cell. However, a UTRAN cell is usually reselected as soon as the user terminal moves back to a coverage area of a UTRAN cell.

There are, however problems relating to ISHO from a GSM cell to a UTRAN cell. When the signal quality varies a lot, as is often the case with a UTRAN cell, handovers between a UTRAN cell and a GSM cell may be performed back and forth resulting in a ping-pong phenomenon. This kind of unnecessary cell reselection causes remarkable data outage time to the end user and substantially slows down the average data transfer rate. At worst, the connection to the UTRAN cell may be lost.

An IS-NCCR (Intersystem Network Controlled Cell Reselection) feature has been designed in an attempt to improve the intersystem handover functionality, but actually it does not increase ISHO's resistance against ping-pong phenomenon at all. Hence, the data rates remain low.

### BRIEF DESCRIPTION OF THE INVENTION

An object of the invention is to provide an improved method, an improved radio system, an improved base station controller, an improved computer program product and an improved computer program distribution medium.

According to an aspect of the invention, there is provided a method of selecting a target for an intersystem cell reselection in a telecommunication system including at least one Universal Mobile Telephone System Terrestrial Radio Access Network (UTRAN) cell and at least one Global System for Mobile Communications (GSM) cell. The method comprises performing measurements of at least one pilot signal by a user terminal having packet switched connection with a GSM cell, at least one of the at least one measured pilot signals being transmitted by a UTRAN cell; transmitting measurement reports of the measurements including pieces of information on the quality of the at least one pilot signal from the user terminal to a base station controller; comparing the quality of the at least one pilot signal originating from a UTRAN cell with a predetermined threshold in the base station controller; selecting a UTRAN cell as a candidate target of an intersystem cell reselection at a crossing moment where the quality of the pilot signal from the UTRAN cell becomes better than a predetermined threshold quality; and starting a predetermined threshold period of time at the crossing moment for checking whether the quality of the pilot signal maintains better than the predetermined threshold quality during the threshold period of time.

According to another aspect of the invention, there is provided a method of performing an intersystem cell reselection in a telecommunication system including at least one Universal Mobile Telephone System Terrestrial Radio Access Network (UTRAN) cell and at least one Global System for Mobile Communications (GSM) cell. The method comprises performing measurements of at least one pilot signal by a user terminal having packet switched connection with a GSM cell, at least one of the at least one measured pilot signals being transmitted by a UTRAN cell; transmitting measurement reports of the measurements including pieces of information on the quality of the at least one pilot signal from the user terminal to a base station controller; comparing the quality of the at least one pilot signal originating from the UTRAN cell with a predetermined threshold in the base station controller; and performing an intersystem cell reselection from the GSM cell to a UTRAN cell if the quality of the pilot signal from the UTRAN cell maintains better than a predetermined threshold for a predetermined threshold period of time.

According to another aspect of the invention, there is provided a radio system configured to select a target for an intersystem cell reselection, the radio system including at least one Universal Mobile Telephone System Terrestrial Radio Access Network (UTRAN) cell and at least one Global System for Mobile Communications (GSM) cell. The radio system comprises a user terminal and a base station controller, wherein the user terminal is configured to perform measurements of at least one pilot signal by a user terminal having packet switched connection with a GSM cell, at least one of the at least one measured pilot signals being transmitted by a UTRAN cell, and transmit measurement reports of the measurements including pieces of information on the quality of the at least one pilot signal to a base station controller; the base station controller is configured to compare the quality of the at least one pilot signal originating from a UTRAN cell with a predetermined threshold in the base station controller, and select a UTRAN cell as a candidate target of an intersystem cell reselection at a crossing moment where the quality of the pilot signal from the UTRAN cell becomes better than a predetermined threshold quality; and start a predetermined threshold period of time at the crossing moment for checking whether the quality of the pilot signal maintains better than the predetermined threshold quality during the threshold period of time.

According to another aspect of the invention, there is provided a radio system configured to perform an intersystem cell reselection, the radio system including at least one Universal Mobile Telephone System Terrestrial Radio Access Network (UTRAN) cell and at least one Global System for Mobile Communications (GSM) cell. The radio system comprises a user terminal and a base station controller, wherein the user terminal is configured to perform measurements of at least one pilot signal by a user terminal having packet switched connection with a GSM cell, at least one of the at least one measured pilot signals being transmitted by a UTRAN cell, and transmit measurement reports of the measurements including pieces of information on the quality of the at least one pilot signal from the user terminal to a base station controller; the base station controller is configured to compare the quality of the at least one pilot signal originating from the UTRAN cell with a predetermined threshold in the base station controller, and perform an intersystem cell reselection from the GSM cell to a UTRAN cell if the quality of the pilot signal from the UTRAN cell maintains better than a predetermined threshold for a predetermined threshold period of time.

According to another aspect of the invention, there is provided a base station controller configured to control an intersystem cell reselection in a radio system including at least one Universal Mobile Telephone System Terrestrial Radio Access Network (UTRAN) cell and at least one Global System for Mobile Communications (GSM) cell. The base station controller is configured to receive measurement reports of measurements of at least one pilot signal of a UTRAN cell, the measurements made by a user terminal having packet switched connection with a GSM cell, the measurement reports including pieces of information on the quality of the at least one pilot signal and transmitted by the user terminal, compare the quality of the at least one pilot signal originating from the UTRAN cell with a predetermined threshold, and select a UTRAN cell as a candidate target of an intersystem cell reselection at a crossing moment where the quality of the pilot signal from the UTRAN cell becomes better than a predetermined threshold quality; and start a predetermined threshold period of time at the crossing moment for checking whether the quality of the pilot signal maintains better than the predetermined threshold quality during the threshold period of time.

According to another aspect of the invention, there is provided a base station controller configured to control an intersystem cell reselection in a radio system including at least one Universal Mobile Telephone System Terrestrial Radio Access Network (UTRAN) cell and at least one Global System for Mobile Communications (GSM) cell. The base station controller is configured to receive measurement reports of measurements of at least one pilot signal of a UTRAN cell, the measurements made by a user terminal having packet switched connection with a GSM cell, the measurement reports including pieces of information on the quality of the at least one pilot signal and transmitted by the user terminal, compare the quality of the at least one pilot signal originating from the UTRAN cell with a predetermined threshold, and perform an intersystem cell reselection from the GSM cell to a UTRAN cell if the quality of the pilot signal from the UTRAN cell maintains better than a predetermined threshold for a predetermined threshold period of time.

According to another aspect of the invention, there is provided a base station controller configured to control an intersystem cell reselection in a radio system including at least one Universal Mobile Telephone System Terrestrial Radio Access Network (UTRAN) cell and at least one Global System for Mobile Communications (GSM) cell. The base station controller comprises means for receiving measurement reports of measurements of at least one pilot signal of a UTRAN cell, the measurements made by a user terminal having packet switched connection with a GSM cell, the measurement reports including pieces of information on the quality of the at least one pilot signal and transmitted by the user terminal, means for comparing the quality of the at least one pilot signal originating from the UTRAN cell with a predetermined threshold, and means for selecting a UTRAN cell as a candidate target of an intersystem cell reselection at a crossing moment where the quality of the pilot signal from the UTRAN cell becomes better than a predetermined threshold quality; and means for measuring the quality of the pilot signal during a predetermined period of time starting at the crossing moment for checking whether the quality of the pilot signal maintains better than the predetermined threshold quality during the threshold period of time.

According to another aspect of the invention, there is provided a base station controller configured to control an intersystem cell reselection in a radio system including at least one Universal Mobile Telephone System Terrestrial Radio Access Network (UTRAN) cell and at least one Global System for Mobile Communications (GSM) cell. The base station controller comprises means for receiving measurement reports of measurements of at least one pilot signal of a UTRAN cell, the measurements made by a user terminal having packet switched connection with a GSM cell, the measurement reports including pieces of information on the quality of the at least one pilot signal and transmitted by the user terminal, means for comparing the quality of the at least one pilot signal originating from the UTRAN cell with a predetermined threshold, and means for performing an intersystem cell reselection from the GSM cell to a UTRAN cell if the quality of the pilot signal from the UTRAN cell maintains better than a predetermined threshold for a predetermined threshold period of time.

According to another aspect of the invention, there is provided a computer program product encoding a computer program of instructions for executing a computer process for selecting a target for an intersystem cell reselection in a telecommunication system including at least one Universal Mobile Telephone System Terrestrial Radio Access Network (UTRAN) cell and at least one Global System for Mobile Communications (GSM) cell. The process comprises: performing measurements of at least one pilot signal by a user terminal having packet switched connection with a GSM cell, at least one of the at least one measured pilot signals being transmitted by a UTRAN cell; transmitting measurement reports of the measurements including pieces of information on the quality of the at least one pilot signal from the user terminal to a base station controller; comparing the quality of the at least one pilot signal originating from a UTRAN cell with a predetermined threshold in the base station controller; selecting a UTRAN cell as a candidate target of an intersystem cell reselection at a crossing moment where the quality of the pilot signal from the UTRAN cell becomes better than a predetermined threshold quality; and starting a predetermined threshold period of time at the crossing moment for checking whether the quality of the pilot signal maintains better than the predetermined threshold quality during the threshold period of time.

According to another aspect of the invention, there is provided a computer program product encoding a computer program of instructions for executing a computer process for performing an intersystem cell reselection in a telecommunication system including at least one Universal Mobile Telephone System Terrestrial Radio Access Network (UTRAN) cell and at least one Global System for Mobile Communications (GSM) cell. The process comprises: performing measurements of at least one pilot signal by a user terminal having packet switched connection with a GSM cell, at least one of the at least one measured pilot signals being transmitted by a UTRAN cell; transmitting measurement reports of the measurements including pieces of information on the quality of the at least one pilot signal from the user terminal to a base station controller; comparing the quality of the at least one pilot signal originating from the UTRAN cell with a predetermined threshold in the base station controller; and performing an intersystem cell reselection from the GSM cell to a UTRAN cell if the quality of the pilot signal from the UTRAN cell maintains better than a predetermined threshold for a predetermined threshold period of time.

According to another aspect of the invention, there is provided a computer program distribution medium readable by a computer and encoding a computer program of instructions for executing a computer process for selecting a target for an intersystem cell reselection in a telecommunication system including at least one Universal Mobile Telephone System Terrestrial Radio Access Network (UTRAN) cell and at least one Global System for Mobile Communications (GSM) cell. The process comprises: performing measurements of at least one pilot signal by a user terminal having packet switched connection with a GSM cell, at least one of the at least one measured pilot signals being transmitted by a UTRAN cell; transmitting measurement reports of the measurements including pieces of information on the quality of the at least one pilot signal from the user terminal to a base station controller; comparing the quality of the at least one pilot signal originating from a UTRAN cell with a predetermined threshold in the base station controller; selecting a UTRAN cell as a candidate target of an intersystem cell reselection at a crossing moment where the quality of the pilot signal from the UTRAN cell becomes better than a predetermined threshold quality; and starting a predetermined threshold period of time at the crossing moment for checking whether the quality of the pilot signal maintains better than the predetermined threshold quality during the threshold period of time.

According to another aspect of the invention, there is provided a computer program distribution medium readable by a computer and encoding a computer program of instructions for executing a computer process for performing an intersystem cell reselection in a telecommunication system including at least one Universal Mobile Telephone System Terrestrial Radio Access Network (UTRAN) cell and at least one Global System for Mobile Communications (GSM) cell. The process comprises: performing measurements of at least one pilot signal by a user terminal having packet switched connection with a GSM cell, at least one of the at least one measured pilot signals being transmitted by a UTRAN cell; transmitting measurement reports of the measurements including pieces of information on the quality of the at least one pilot signal from the user terminal to a base station controller; comparing the quality of the at least one pilot signal originating from the UTRAN cell with a predetermined threshold in the base station controller; and performing an intersystem cell reselection from the GSM cell to a UTRAN cell if the quality of the pilot signal from the UTRAN cell maintains better than a predetermined threshold for a predetermined threshold period of time.

The invention provides several advantages. When connected in the GSM cell, the selection of a target cell in the UTRAN cell is effective and reliable. The oft-repeated handovers called ping-ponging between the GSM cell and the UTRAN cell can be avoided, resulting in good service and high averaged data rates.

### LIST OF DRAWINGS

In the following, the invention will be described in greater detail with reference to the embodiments and the accompanying drawings, in which

FIG. 1 shows a block diagram of a radio system;

FIG. 2 illustrates fluctuation of quality and threshold levels,

FIG. 3 illustrates IS-NCCR functionality,

FIG. 4 illustrates IS-NCCR functionality with a timer,

FIG. 5 illustrates a flowchart of selecting a candidate target cell, and

FIG. 6 illustrates a flowchart of performing an intersystem cell reselection.

### DESCRIPTION OF EMBODIMENTS

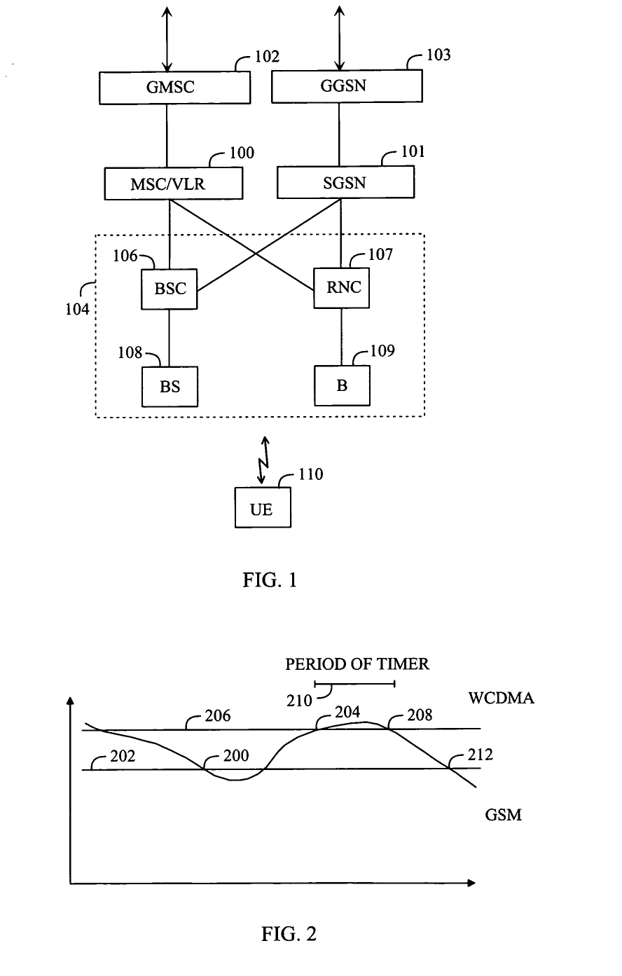

Let us first study FIG. 1 that illustrates the structure of a radio system. The core network of the radio system may comprise two telecommunication networks such as the UMTS and the GSM. Both networks can offer packet-switched connections. The UMTS (Universal Mobile Telephone System) may utilize the WCDMA (Wide-band Code Division Multiple Access) technology. In the GSM, the GPRS (General Packet Radio Service) may be applied, and the EGPRS (Enhanced GPRS) system may also utilize the GSM/EDGE (GSM/Enhanced Data Rates for Global Evolution) technology. The GSM network has elements responsible for the implementation of circuit-switched connections, and the GPRS network elements for the implementation of packet-switched connections, some of the network elements may, however, be common to both switchings.

A mobile services switching centre (MSC) 100 enables circuit-switched signalling in the radio system. A serving GPRS support node (SGSN) 101 in turn enables packet-switched signalling.

The core network relating to both the GSM and the UMTS may have a gateway unit 102, which represents a gateway mobile service switching centre (GMSC) for attending to the circuit-switched connections between the core network and external networks, such as a public land mobile network (PLMN) or a public switched telephone net-work (PSTN). Correspondingly, the gateway GPRS support node (GGSN) 103 of the packet subsystem attends to the packet-switched connections between the core network and external networks, such as the Internet.

The MSC 100 and the SGSN are connected to a radio access net-work (RAN) 104. In the GSM, the RAN may comprise at least one base station controller 106 controlling at least one base station 108 (i.e. GSM cell). The UTRAN may comprise at least one radio network controller 107 which corresponds to the base station controller 106 in the GSM. In the UTRAN, the radio network controller 107 controls at least one node B 109 (i.e. UTRAN cell) which corresponds to a base station in the GSM.

The circuit-switched traffic can be passed towards the gateway unit 102 through either the interface A or the interface Iu-Cs. The packet-switched traffic can be passed towards the gateway node 103 through either the interface Gb or the interface Iu-Ps.

A user terminal 110 may communicate with a base station 108 or a node B 109 over a radio interface.

At first, the user terminal 110 can communicate with the node B 109 (i.e. UTRAN cell) using a packet switched mode. Data in packets may contain address and control data in addition to the actual traffic data. Several connections may employ the same transmission channel simultaneously. A packet-switching method is suitable for data transmission where the data to be transmitted is generated in bursts. In such a case, it is not necessary to allocate a data link for the entire duration of transmission but only for the time it takes to transmit the packets. This reduces costs and saves capacity considerably during both the set-up and the use of the network.

FIG. 2 can be used to refer to both the prior art and to the present solution. In FIG. 2 a user terminal is communicating using a packet switched mode with a UTRAN cell at first. The vertical axis represents signal quality, for example, common pilot channel's signal-noise ratio CPICH Ec/No and the horizontal axis represents time T. At a moment 200, signal quality drops below a first threshold level 202 which initiates a cell reselection procedure, and the cell reselection from a UTRAN cell to a GSM cell is performed. At a moment 204, signal quality crosses a second threshold 206 level where an intersystem cell reselection from a GSM cell to a UTRAN cell may be initiated. In prior art, the cell reselection is actually performed. However, rather soon at a moment 212, the signal quality drops below the first threshold level 202 and again an intersystem cell reselection from a UTRAN cell to a GSM cell has to be performed according to the prior art.

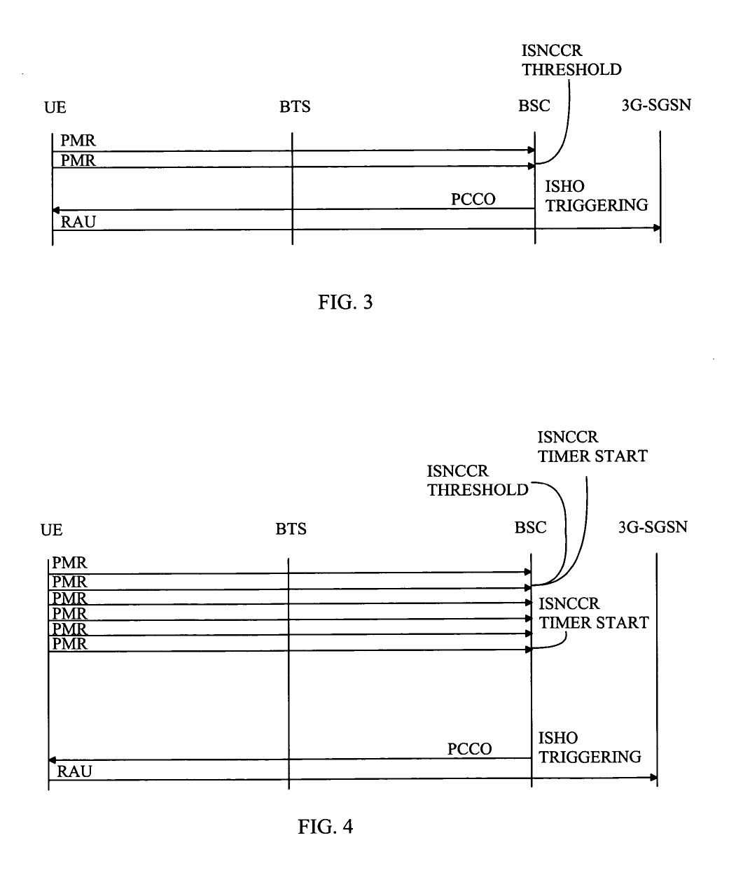

FIG. 3 shows signalling between the core network and the user terminal for the purpose of an intersystem cell reselection according to the prior art. When a user terminal UE has a packet switched connection to a GSM cell, the user terminal performs measurements of at least one pilot signal, at least one of the pilot signals being possibly related to a UTRAN cell. The pilot signal may be a CPICH signal (Common Pilot Channel). The user terminal keeps transmitting measurement reports (PMR) of the measurements including pieces of information on the quality of the at least one pilot signal to a base station of a GSM radio system which relays the measurement reports to a base station controller of a GSM radio system. The base station controller may compare the quality of the at least one pilot signal originating from a UTRAN cell with a predetermined threshold (level 206 in FIG. 2). Actually, the base station controller has a PCU (Packet Control Unit) for performing the comparison. The base station controller selects a UTRAN cell as a target of an intersystem cell reselection at a crossing moment 204 where the quality of the pilot signal from the UTRAN cell becomes better than a predetermined threshold quality (level 206 in FIG. 2).

When the base station controller has decided on the target base station for the cell reselection, the base station controller commands the user terminal to change the cell to a UTRAN cell using a signal of packet_cell_change_order (PCCO). When the user terminal receives the command, the user terminal transmits a request for updating the routing area to UTRAN using a signal of routing_area_update_request (RAU).

The UTRAN cell should be selected when the signal quality is stable and good enough. When using the IS-NCCR, the decision is made on the basis of the signal quality and a UTRAN cell with fluctuating CPICH Ec/No can be selected. This may lead to ping-ponging, the end user being without service up to tens of seconds, or in the worst case the connection to the UTRAN may be dropped completely.

FIG. 4 shows signalling between the core network and the user terminal for the purpose of an intersystem cell reselection according to the present solution. When a user terminal UE has a packet switched connection to a GSM cell with packet switching, the user terminal performs measurements of at least one pilot signal, each pilot signal relating to a UTRAN cell. The GSM cell may be a usual GSM cell or an enhanced GSM cell called a GERAN cell (Global System for Mobile Communications/Enhanced Data Rates for Global Evolution). The pilot signal may be a CPICH signal (Common Pilot Channel). The user terminal keeps transmitting measurement reports of the measurements including pieces of information on the quality of the at least one pilot signal to a base station of a GSM radio system which relays the measurement reports to a base station controller of a GSM radio system. The base station controller may compare the quality of the at least one pilot signal originating from a UTRAN cell with a predetermined threshold (level 206 in FIG. 2).

The base station controller may have a PCU (Packet Control Unit) for performing the comparison. The base station controller may select a UTRAN cell as a candidate target of an intersystem cell reselection at a crossing moment 204 where the quality of the pilot signal from the UTRAN cell becomes better than a predetermined threshold quality (level 206 in FIG. 2). A predetermined threshold period of time 210 is started at the crossing moment for checking whether the quality of the pilot signal maintains better than the predetermined threshold quality during the threshold period of time. If the quality of the pilot signal maintains better than the threshold quality, the cell reselection may be performed.

When the signal quality crosses the second threshold level 206, a timer may be started in the base station controller. The timer can be a counter which may reside in the PCU. When the signal quality crosses the second threshold level 206 at the moment 208, the counter is reset to zero and the counter may start again only at signal quality crossing the second threshold level. If, however, the counter can count upto a predetermined value, the complete counting process corresponding to the predetermined threshold period of time, a target cell can be determined and the cell reselection can be performed.

The duration of the predetermined threshold period of time may be adaptive such that the duration may be varied. The duration may be varied as a function of one or a plurality of reasons or properties, such as network configuration, loading, environment, time etc. For example, the duration may be longer in an urban area than in a rural area. The variation may be controlled by the operator of the radio system by adjusting parameterisation i.e. length of the predetermined threshold period of time. That can be adjusted by changing the starting value or the stopping value or both the starting value and the stopping value of the counter. Usually the threshold period of time is determined by a simple timer whose period can be set as seconds. The scale may be, for example, from 0 to a desired number of seconds.

When a base station controller has decided on the target base station for the intersystem cell reselection, the process of the cell reselection continues in a similar manner to the prior art. The base station controller commands the user terminal to change the cell to a UTRAN cell using, for example, a signal of packet_cell_change_order. When the user terminal receives the command, the user terminal transmits a request for updating the routing area to a 3G-SGSN of the UTRAN using, for example, a signal of routing_area_update_request. The term 3G-SGSN means SGSN of the third generation (3G) where the third generation refers to the UTRAN.

In an embodiment, the quality of the pilot signal originating from a UTRAN cell may be averaged and the averaged quality may be compared with the predetermined threshold. This procedure allows the pilot signal to drop occasionally below the threshold during good reception without jeoparding an advantageous cell reselection.

An example can be given using FIG. 2. At a moment 204, signal quality crosses a second threshold level 206 where an intersystem cell reselection from a GSM cell to a UTRAN cell may be initiated. In prior art, the intersystem cell reselection is actually performed but according to an embodiment of the present solution the intersystem cell reselection is not performed. The reason for that is that rather soon at a moment 208, the signal quality drops below the second threshold level 206 again. That is, the good quality of the service continues in this example for a shorter time than the predetermined threshold period of time 210. Hence, the intersystem cell reselection is not performed. Had the good quality continued for a longer time than the predetermined period of time 210, the hand over would have been performed.

The averaging may be formed by calculating a predetermined number of successive values of quality of the at least one pilot signal originating from the UTRAN cell together and dividing the sum by the number of values. Mathematically that can be expressed as

$${q}_{av} = ( 1 / N ) {\sum }_{i = 1}^{N} q ( i ) ,$$

where i is an index of samples, q(i) is a quality of a measured sample i and N is the number of samples. The averaging may also be calculated as a median or a mode. When considering the variation of quality as a random process, the median q_{median} can mathematically be expressed as

$${\int }_{- ∞}^{{q}_{median}} p ( q ) ⅆ q = 0.5 ,$$

where p(q) represents a probability of a quality q. The mode, in turn, can be considered as the most likely quality such that the probability p(q_{mode}) is the highest. The use of the mode is simple if the density is unimodal (i.e. only one mode). In the case of bimodal and multimodal densities one of the modes can be selected.

The decision of a target cell made by the base station controller can be performed by searching for a pilot signal whose quality is the best, and selecting the UTRAN cell transmitting a pilot signal of the best quality as a target of the intersystem cell reselection.

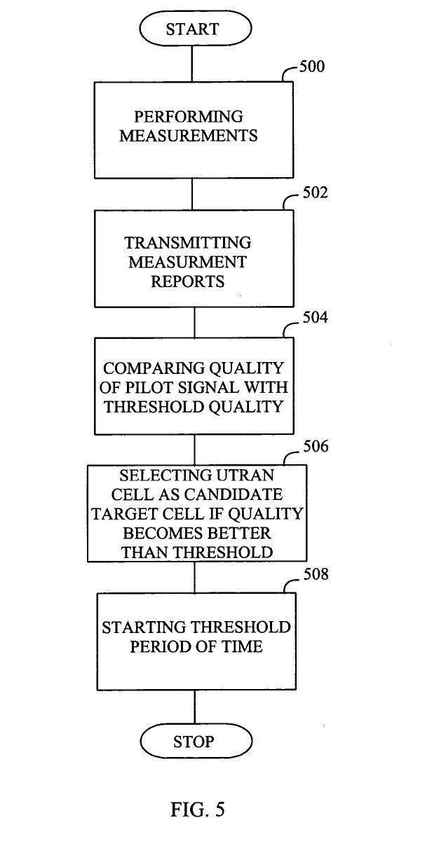

FIG. 5 illustrates the flowchart of the method for selecting a candidate target for an intersystem cell reselection in a telecommunication system including at least one Universal Mobile Telephone System Terrestrial Radio Access Network (UTRAN) cell and at least one Global System for Mobile Communications (GSM) Radio Access Network (RAN) cell. In step 500, measurements of at least one pilot signal are performed by a user terminal having packet switched connection with a GSM cell, at least one of the at least one measured pilot signals being transmitted by a UTRAN cell. In step 502, measurement reports of the measurements including pieces of information on the quality of the at least one pilot signal are transmitted from the user terminal to a base station controller. In step 504, the quality of the at least one pilot signal originating from a UTRAN cell is compared with a predetermined threshold in the base station controller. In step 506, a UTRAN cell is selected as a candidate target of an intersystem cell reselection at a crossing moment where the quality of the pilot signal from the UTRAN cell becomes better than a predetermined threshold quality. In step 508, a predetermined threshold period of time is started at the crossing moment for checking whether the quality of the pilot signal maintains better than the predetermined threshold quality during the threshold period of time.

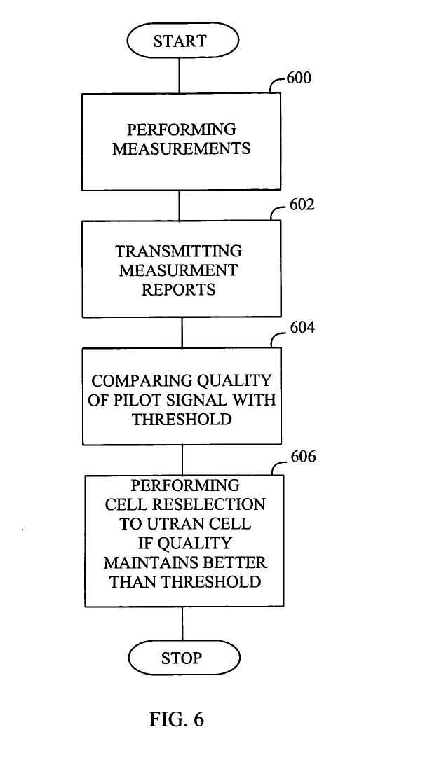

FIG. 6 illustrates the flowchart of the method for performing an intersystem cell reselection in a telecommunication system including Universal Mobile Telephone System Terrestrial Radio Access Network (UTRAN) cells and Global System for Mobile Communications (GSM) Radio Access Network (RAN) cells. In step 600, measurements of at least one pilot signal are performed by a user terminal having packet switched connection with a GSM cell, at least one of the at least one measured pilot signals being transmitted by a UTRAN cell, In step 602, measurement reports of the measurements including pieces of information on the quality of the at least one pilot signal are transmitted from the user terminal to a base station controller. In step 604, the quality of the at least one pilot signal originating from the UTRAN cell is compared with a predetermined threshold in the base station controller. In step 606, an intersystem cell reselection is performed from the GSM cell to a UTRAN cell if the quality of the pilot signal from the UTRAN cell maintains better than a predetermined threshold for a predetermined threshold period of time.

The base station controller is typically implemented with a processor and associated software. Hence, the base station controller may be configured to perform the steps described in connection with the flowchart of FIG. 5. The embodiments may be implemented as a computer program comprising instructions for executing a computer process for selecting a target for an intersystem cell reselection in a telecommunication system including Universal Mobile Telephone System Terrestrial Radio Access Network (UTRAN) cells and Global System for Mobile Communications (GSM) cells.

The base station controller may also be configured to perform at least some of the steps described in connection with the flowchart of FIG. 6. The embodiments may be implemented as a computer program comprising instructions for executing a computer process for performing an intersystem cell reselection in a telecommunication system including Universal Mobile Telephone System Terrestrial Radio Access Network (UTRAN) cells and Global System for Mobile Communications (GSM) cells.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Even though the invention is described above with reference to an example according to the accompanying drawings, it is clear that the invention is not restricted thereto but it can be modified in several ways within the scope of the appended claims.

1. A method of selecting a target for an intersystem cell reselection in a telecommunication system including at least one Universal Mobile Telephone System Terrestrial Radio Access Network (UTRAN) cell and at least one Global System for Mobile Communications (GSM) cell, the method comprising:
performing measurements of at least one pilot signal by a user terminal having packet switched connection with a GSM cell, at least one of the at least one measured pilot signals being transmitted by a UTRAN cell;
transmitting measurement reports of the measurements, wherein the measurement reports include pieces of information on the quality of the at least one pilot signal from the user terminal;
comparing the quality of the at least one pilot signal transmitted from a UTRAN cell with a predetermined threshold in the base station controller;
selecting a UTRAN cell as a candidate target of an intersystem cell reselection at a crossing moment where the quality of the pilot signal from the UTRAN cell becomes greater than a predetermined threshold quality; and
starting a predetermined threshold period of time at the crossing moment for checking whether the quality of the pilot signal remains greater than the predetermined threshold quality during the threshold period of time.

2. A method of performing an intersystem cell reselection in a telecommunication system including at least one Universal Mobile Telephone System Terrestrial Radio Access Network (UTRAN) cell and at least one Global System for Mobile Communications (GSM) cell, the method comprising:
performing measurements of at least one pilot signal by a user terminal having packet switched connection with a GSM cell, at least one of the at least one measured pilot signals being transmitted by a UTRAN cell;
transmitting measurement reports of the measurements wherein the measurement reports include pieces of information on the quality of the at least one pilot signal from the user terminal to a base station controller;
comparing the quality of the at least one pilot signal originating from the UTRAN cell with a predetermined threshold in the base station controller; and
performing an intersystem cell reselection from the GSM cell to a UTRAN cell if the quality of the pilot signal from the UTRAN cell remains greater than a predetermined threshold for a predetermined threshold period of time.

3. The method of claim 2, the method further comprising varying duration of the predetermined threshold period of time.

4. The method of claim 3, the method further comprising performing variation on the duration of the predetermined threshold period of time as a function of an environment in the cell.

5. The method of claim 2, the method further comprising averaging quality of the at least one pilot signal originating from the UTRAN cell and comparing the averaged quality with the predetermined threshold.

6. The method of claim 5, the method further comprising averaging a predetermined number of successive values of quality of the at least one pilot signal originating from the UTRAN cell and comparing the averaged quality with the predetermined threshold.

7. The method of claim 2, the method further comprising searching for, by the base station controller, a pilot signal having the best quality, and selecting the UTRAN cell transmitting the pilot signal of the best quality as a target of the intersystem cell reselection.

8. The method of claim 2, the method further comprising performing an intersystem cell reselection from a Global System for Mobile Communications/Enhanced Data Rates for Global Evolution (GERAN) cell to a UTRAN cell.

9. A radio system configured to select a target for an intersystem cell reselection, the radio system including at least one Universal Mobile Telephone System Terrestrial Radio Access Network (UTRAN) cell and at least one Global System for Mobile Communications (GSM) cell, and the radio system comprising a user terminal and a base station controller, wherein
the user terminal is configured to:
perform measurements of at least one pilot signal by a user terminal having packet switched connection with a GSM cell, at least one of the at least one measured pilot signals being transmitted by a UTRAN cell, and
transmit measurement reports of the measurements, wherein the measurement reports include pieces of information on the quality of the at least one pilot signal to a base station controller; and wherein
the base station controller is configured to:
compare the quality of the at least one pilot signal originating from a UTRAN cell with a predetermined threshold in the base station controller, and
select a UTRAN cell as a candidate target of an intersystem cell reselection at a crossing moment where the quality of the pilot signal from the UTRAN cell becomes greater than a predetermined threshold quality; and
start a predetermined threshold period of time at the crossing moment for checking whether the quality of the pilot signal remains greater than the predetermined threshold quality during the threshold period of time.

10. A radio system configured to perform an intersystem cell reselection, the radio system including at least one Universal Mobile Telephone System Terrestrial Radio Access Network (UTRAN) cell and at least one Global System for Mobile Communications (GSM) cell, and the radio system comprising a user terminal and a base station controller, wherein
the user terminal is configured to:
perform measurements of at least one pilot signal by a user terminal having packet switched connection with a GSM cell, at least one of the at least one measured pilot signals being transmitted by a UTRAN cell, and
transmit measurement reports of the measurements, wherein the measurement reports include pieces of information on the quality of the at least one pilot signal from the user terminal to a base station controller; and wherein
the base station controller is configured to:
compare the quality of the at least one pilot signal originating from the UTRAN cell with a predetermined threshold in the base station controller, and
perform an intersystem cell reselection from the GSM cell to a UTRAN cell if the quality of the pilot signal from the UTRAN cell remains greater than a predetermined threshold for a predetermined threshold period of time.

11. The radio system of claim 10, wherein the base station controller is configured to set a duration of the predetermined threshold period of time.

12. The radio system of claim 11, wherein the base station controller is configured to vary the duration of the predetermined threshold period of time as a function of environment in the cell.

13. The radio system of claim 10, wherein the base station controller is configured to determine an average quality of the at least one pilot signal originating from the UTRAN cell and to compare the averaged quality with the predetermined threshold.

14. The radio system of claim 13, wherein the base station is configured to determine an average of a predetermined number of successive values of quality of the at least one pilot signal originating from the UTRAN cell and comparing the averaged quality with the predetermined threshold.

15. The radio system of claim 10, wherein the base station is configured to search for a pilot signal having the best quality, and to select the UTRAN cell transmitting the pilot signal of the best quality as a target of the intersystem cell reselection.

16. The radio system of claim 10, wherein the GSM cell is a Global System for Mobile Communications/Enhanced Data Rates for Global Evolution (GERAN) cell.

17. A base station controller configured to control an intersystem cell reselection in a radio system including at least one Universal Mobile Telephone System Terrestrial Radio Access Network (UTRAN) cell and at least one Global System for Mobile Communications (GSM) cell, wherein
the base station controller is configured to:
receive measurement reports of measurements of at least one pilot signal of a UTRAN cell, wherein the measurements are made by a user terminal having packet switched connection with a GSM cell, the measurement reports include pieces of information on the quality of the at least one pilot signal and transmitted by the user terminal,
compare the quality of the at least one pilot signal originating from the UTRAN cell with a predetermined threshold, and
select a UTRAN cell as a candidate target of an intersystem cell reselection at a crossing moment where the quality of the pilot signal from the UTRAN cell becomes greater than a predetermined threshold quality; and
start a predetermined threshold period of time at the crossing moment for checking whether the quality of the pilot signal remains greater than the predetermined threshold quality during the threshold period of time.

18. A base station controller configured to control an intersystem cell reselection in a radio system including at least one Universal Mobile Telephone System Terrestrial Radio Access Network (UTRAN) cell and at least one Global System for Mobile Communications (GSM) cell, wherein
the base station controller is configured to:
receive measurement reports of measurements of at least one pilot signal of a UTRAN cell, the measurements made by a user terminal having packet switched connection with a GSM cell, the measurement reports including pieces of information on the quality of the at least one pilot signal and transmitted by the user terminal,
compare the quality of the at least one pilot signal originating from the UTRAN cell with a predetermined threshold, and
perform an intersystem cell reselection from the GSM cell to a UTRAN cell if the quality of the pilot signal from the UTRAN cell remains greater than a predetermined threshold for a predetermined threshold period of time.

19. A base station controller configured to control an intersystem cell reselection in a radio system including at least one Universal Mobile Telephone System Terrestrial Radio Access Network (UTRAN) cell and at least one Global System for Mobile Communications (GSM) cell, wherein
the base station controller comprises:
means for receiving measurement reports of measurements of at least one pilot signal of a UTRAN cell, the measurements made by a user terminal having packet switched connection with a GSM cell, wherein the measurement reports include pieces of information on the quality of the at least one pilot signal and transmitted by the user terminal,
means for comparing the quality of the at least one pilot signal originating from the UTRAN cell with a predetermined threshold, and
means for selecting a UTRAN cell as a candidate target of an intersystem cell reselection at a crossing moment where the quality of the pilot signal from the UTRAN cell becomes greater than a predetermined threshold quality; and
means for measuring the quality of the pilot signal during a predetermined period of time starting at the crossing moment for checking whether the quality of the pilot signal remains greater than the predetermined threshold quality during the threshold period of time.

20. A base station controller configured to control an intersystem cell reselection in a radio system including at least one Universal Mobile Telephone System Terrestrial Radio Access Network (UTRAN) cell and at least one Global System for Mobile Communications (GSM) cell, wherein
the base station controller comprises:
means for receiving measurement reports of measurements of at least one pilot signal of a UTRAN cell, the measurements made by a user terminal having packet switched connection with a GSM cell, wherein the measurement reports include pieces of information on the quality of the at least one pilot signal and transmitted by the user terminal,
means for comparing the quality of the at least one pilot signal originating from the UTRAN cell with a predetermined threshold, and
means for performing an intersystem cell reselection from the GSM cell to a UTRAN cell if the quality of the pilot signal from the UTRAN cell remains greater than a predetermined threshold for a predetermined threshold period of time.

21. A computer program embodied on a computer readable medium comprising instructions for executing a computer process for selecting a target for an intersystem cell reselection in a telecommunication system including at least one Universal Mobile Telephone System Terrestrial Radio Access Network (UTRAN) cell and at least one Global System for Mobile Communications (GSM) cell, wherein the process comprises:
performing measurements of at least one pilot signal by a user terminal having packet switched connection with a GSM cell, at least one of the at least one measured pilot signals being transmitted by a UTRAN cell;
transmitting measurement reports of the measurements, wherein the measurement reports include pieces of information on the quality of the at least one pilot signal from the user terminal to a base station controller;
comparing the quality of the at least one pilot signal originating from a UTRAN cell with a predetermined threshold in the base station controller;
selecting a UTRAN cell as a candidate target of an intersystem cell reselection at a crossing moment where the quality of the pilot signal from the UTRAN cell becomes greater than a predetermined threshold quality; and
starting a predetermined threshold period of time at the crossing moment for checking whether the quality of the pilot signal remains greater than the predetermined threshold quality during the threshold period of time.

22. A computer program embodied on a computer readable medium comprising instructions for executing a computer process for performing an intersystem cell reselection in a telecommunication system including at least one Universal Mobile Telephone System Terrestrial Radio Access Network (UTRAN) cell and at least one Global System for Mobile Communications (GSM) cell, wherein the process comprises:
performing measurements of at least one pilot signal by a user terminal having packet switched connection with a GSM cell, at least one of the at least one measured pilot signals being transmitted by a UTRAN cell;
transmitting measurement reports of the measurements, wherein the measurement reports include pieces of information on the quality of the at least one pilot signal from the user terminal to a base station controller;
comparing the quality of the at least one pilot signal originating from the UTRAN cell with a predetermined threshold in the base station controller; and
performing an intersystem cell reselection from the GSM cell to a UTRAN cell if the quality of the pilot signal from the UTRAN cell remains greater than a predetermined threshold for a predetermined threshold period of time.

23. The computer readable medium of claim 21, the computer readable medium including at least one of the following media: a program storage medium, a record medium, a computer readable memory, a computer readable software distribution package, a computer readable signal, a computer readable telecommunications signal, and a computer readable compressed software package.

24. The computer readable medium of claim 22, the computer readable medium including at least one of the following media: a program storage medium, a record medium, a computer readable memory, a computer readable software distribution package, a computer readable signal, a computer readable telecommunications signal, and a computer readable compressed software package.
